(19) United States
(12) Patent Application Publication
(10) Pub. No.: US 2015/0254791 A1
(43) Pub. Date: Sep. 10, 2015

(54) QUALITY CONTROL CALCULATOR FOR DOCUMENT REVIEW

(71) Applicant: FMR LLC, Boston, MA (US)

(72) Inventors: Jamal Odin Stockton, Boston, MA (US); Michael Perry Lisi, Raleigh, NC (US); Erica Louise Rhodin, Somerville, MA (US)

(73) Assignee: FMR LLC, Boston, MA (US)

(21) Appl. No.: 14/202,401

(22) Filed: Mar. 10, 2014

(51) Int. Cl. G06Q 50/18; G06Q 10/06

(52) U.S. Cl. CPC G06Q 50/18; G06Q 10/0635

(57) ABSTRACT

Described are methods and apparatuses, including computer program products, for automatically managing quality of human document review in a review process. The method includes receiving tagging decisions for multiple documents made by a first reviewer during a first time period and sampling a subset of these documents based on a first confidence level and first confidence interval. The method further includes receiving tagging decisions made by a second reviewer related to the subset of the documents, from which values of multiple quality-control metrics are determined. The method further includes calculating a risk-accuracy value based in part on the values of the quality-control metrics and recommending a second confidence level and a second confidence interval for sampling a second set of documents reviewed by the first reviewer during a second time period.

### FIELD OF THE INVENTION

The invention generally relates to computer-implemented methods and apparatuses, including computer program products, for automatically managing quality of human document review.

### BACKGROUND

In a legal dispute (e.g., litigation, arbitration, mediation, etc.), a large number of documents are often reviewed and analyzed manually by a team of reviewers, which requires the use of valuable resources, including time, money and man power. Each reviewer can be provided with a set of documents and is asked to determine whether each document satisfies one or more tagging criteria (e.g., responsive, significant, privileged, etc.) based on its content. Such a human review process is often error prone due to, for example, some reviewers not having the appropriate skills to make correct tagging decisions and/or different reviewers applying different standards of review.

### SUMMARY OF THE INVENTION

Therefore, systems and methods are needed to automatically manage quality of document review performed by human reviewers. For example, systems and methods can be used to improve a document review process by automatically identifying current shortcomings and monitoring review progress.

In one aspect, a computerized method is provided for automatically managing quality of human document review in a review process. The method includes receiving, by a computing device, tagging decisions for a plurality of documents made by a first reviewer during a first time period and determining, by the computing device, a subset of the plurality documents based on a first confidence level and first confidence interval. The method further includes receiving, by the computing device, tagging decisions made by a second reviewer related to the subset of the plurality of documents. The computing device then determines values of a plurality of quality-control metrics based on the tagging decisions of the first and second reviewers with respect to the subset of the plurality of documents. The values of the plurality of quality-control metrics reflect a level of identity between the first and second reviewers in relation to a plurality of tagging criteria. The method further includes calculating, by the computing device, a risk-accuracy value as a weighted combination of a plurality of factors including (1) an accuracy factor determined based on the values of the plurality of quality-control metrics; (2) a review rate factor indicating the rate of review of the first reviewer during the first time period; and (3) one or more user-selectable factors reflecting the complexity or difficulty associated with reviewing the plurality of documents. The computing device can recommend a second confidence level and a second confidence interval for sampling a second plurality of documents reviewed during a second time period. The second confidence level and the second confidence interval are determined based on the risk-accuracy value.

In another aspect, a computerized-implemented system is provided for automatically managing quality of human document review in a review process. The computer-implemented system includes an extraction module, a sampling module, a quality control review module, a quality control calculator and a recommendation module. The extraction module is configured to extract tagging decisions for a plurality of documents made by a first reviewer during a first time period. The sampling module is configured to (1) determine a subset of the plurality documents based on a first confidence level and first confidence interval, and (2) receive tagging decisions made by a second reviewer related to the subset of the plurality of documents. The quality control review module is configured to determine values of a plurality of quality-control metrics based on the tagging decisions of the first and second reviewers with respect to the subset of the plurality of documents. The values of the plurality of quality control metrics reflect a level of identity between the first and second reviewers in relation to a plurality of tagging criteria. The quality control calculator is configured to calculate a risk-accuracy value as a weighted combination of a plurality of factors including (1) an accuracy factor determined based on the values of the plurality of quality-control metrics; (2) a review rate factor indicating the rate of review of the first reviewer during the first time period; and (3) one or more user-selectable factors reflecting the complexity associated with reviewing the plurality of documents. The recommendation module is configured to recommend a second confidence level and a second confidence interval for sampling a second plurality of documents reviewed during a second time period. The second confidence level and the second confidence interval are determined based on the risk-accuracy value.

In yet another aspect, a computer program product, tangibly embodied in a non-transitory computer readable medium, is provided for automatically managing quality of human document review in a review process. The computer program product includes instructions being configured to cause data processing apparatus to receive tagging decisions for a plurality of documents made by a first reviewer during a first time period and determine a subset of the plurality documents based on a first confidence level and first confidence interval. The computer program product also includes instructions being configured to cause data processing apparatus to receive tagging decisions made by a second reviewer related to the subset of the plurality of documents and determine values of a plurality of quality-control metrics based on the tagging decisions of the first and second reviewers with respect to the subset of the plurality of documents. The values of the plurality of quality-control metrics reflect a level of identity between the first and second reviewers in relation to a plurality of tagging criteria. The computer program product additionally includes instructions being configured to cause data processing apparatus to calculate a risk-accuracy value as a weighted combination of a plurality of factors including (1) an accuracy factor determined based on the values of the plurality of quality-control metrics; (2) a review rate factor indicating the rate of review of the first reviewer during the first time period; and (3) one or more user-selectable factors reflecting the complexity associated with reviewing the plurality of documents. The computer program product further includes instructions being configured to cause data processing apparatus to recommend a second confidence level and a second confidence interval for sampling a second plurality of documents during a second time period. The second confidence level and the second confidence interval are determined based on the risk-accuracy value.

In other examples, any of the aspects above can include one or more of the following features. In some embodiments, the tagging criteria comprise responsiveness, significance, privileged status and redaction requirement. In some embodiments, each tagging decision comprises a decision regarding whether a family of one or more related documents satisfies at least one of the tagging criteria.

In some embodiments, the values of a plurality of first-level review metrics are calculated. These first-level review metrics characterize the tagging decisions made by the first reviewer. The value of at least one of the first-level review metrics can indicate a percentage of the tagging decisions that satisfies a tagging criterion. The value of each of the first-level review metrics can be computed as an average over a user-selectable time period.

In some embodiments, the plurality of quality-control metrics comprise a recall rate, a precision rate and an F-measure corresponding to each of the plurality of tagging criteria. The recall rate and precision rate can be computed based on a percentage of agreement of tagging decisions between the first and second reviewers with respect to each of the tagging criteria. The F-measure can be computed for each of the plurality of tagging criteria based on the corresponding recall rate and precision rate.

In some embodiments, the accuracy factor comprises a weighted average of the F-measures for the plurality of tagging criteria. In some embodiments, the one or more user-selectable factors comprise a difficulty protocol factor, a deadline factor, a sensitivity factor and a type of data factor. In some embodiments, a plurality of weights are received corresponding to the plurality of factors. These weights can be used to customize the calculation of the risk-accuracy value.

In some embodiments, the second confidence level is inversely related to the risk-accuracy value. For example, an increase in the risk-accuracy value can be indicative of a decrease in accuracy of the first reviewer, an increase in difficulty or complexity of the plurality of documents reviewed, or an abnormal review rate of the first reviewer.

In some embodiments, the first time period is a current day and the second time period is the following day.

In some embodiments, a plurality of cumulative metrics for a duration of the review process are calculated. The plurality of cumulative metrics comprise at least one of the total number documents reviewed, the total number of hours spent by the first reviewer, an average review rate of the first reviewer, a percentage of completion, an overall accuracy value of the first reviewer, an average confidence level, or an average confidence interval.

In some embodiments, data are received in relation to a second review process similar to the review process. The data includes an accuracy threshold to be achieved by the second review process. A plurality of historical cumulative metrics data are then determined, including the plurality of cumulative metrics for the review process and one or more cumulative metrics associated with other review processes similar to the second review process. A cost model is determined based on the historical cumulative metrics data. The cost model illustrates average costs for similar review processes of various durations to achieve the accuracy threshold. Based on the cost model, an optimal duration is determined for the second review process that minimizes costs while satisfying the accuracy threshold. The optimal duration can correspond to a point in the cost model with the lowest average cost.

In some embodiments, based on the optimal duration for the second review process, a recommendation is made including at least one of a number of first-level reviewers or a number of quality-control reviewers to staff to the second review process to realize the optimal duration. In some embodiments, a cost associated with completing the second review process in the optimal duration is estimated and recommended to a user.

In some embodiments, a degree of similarity between the second review process and the other review processes is determined based on a complexity score for each of the review processes.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 shows an exemplary calculator system in an illustrative network environment.

FIG. 2 shows an exemplary process for automatically managing quality of human document review in a review process using the calculator system of FIG. 1.

FIG. 3 shows an exemplary user interface configured to display one or more first level review metrics.

FIG. 4 shows an exemplary user interface configured to display one or more quality control metrics.

FIG. 5 shows an exemplary user interface configured to display one or more factors for calculating a risk accuracy value.

FIG. 6 shows an exemplary chart correlating the accuracy and review rate factors to their respective static values, classifications, weights and weighted scores.

FIG. 7 shows an exemplary chart correlating additional factors to their respective static values, classifications, weights and weighted scores.

FIG. 8 shows an exemplary lookup table correlating various risk accuracy values to their respective confidence levels and confidence intervals.

FIG. 9 shows an exemplary user interface displaying recommended confidence level and confidence interval for sampling the next batch of reviewed documents.

FIG. 10 shows an exemplary cost model utilizing logarithmic trend lines for determining an optimal duration of a document review process.

FIGS. 11A and 11B show an exemplary data table based on which the logarithmic cost model of FIG. 10 is generated.

FIG. 12 shows an exemplary user interface for allowing a user to specify parameters associated with a document review process for which recommendations are generated.

FIG. 13 illustrates an exemplary display configured to show various estimations for a document review process.

### DESCRIPTION OF THE INVENTION

Systems and methods of the present invention provide useful data to a team leader to effectively manage a team of human reviewers and establish confidence that documents are correctly tagged by the reviewers prior to production. In some embodiments, systems and methods of the present invention can use statistical principles to determine the number of documents tagged by at least one first level (FL) reviewer that need to undergo quality control check by a quality control (QC) reviewer. Subsequently, based on the number and type of changes made by the QC reviewer to the selected set of documents, the accuracy of the FL reviewer can be determined. A team leader can use this accuracy calculation to evaluate the performance of the review team as well as the clarity of the quality control protocol. In some embodiments, systems and methods of the present invention also calculate review rates and other quality control metrics related to the performance of the FL reviewers, which the team leader can use to spot issues during the review process.

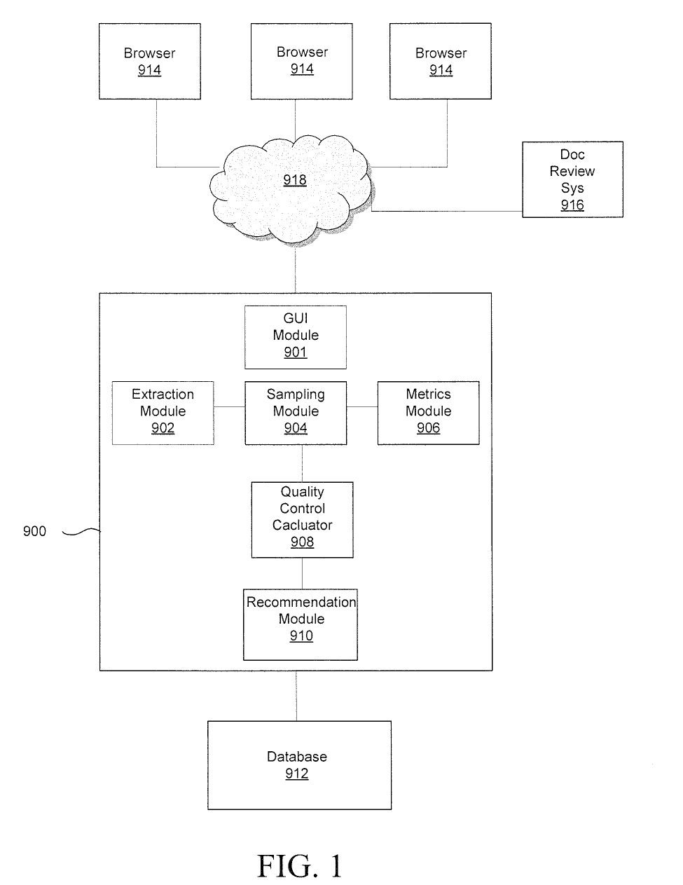

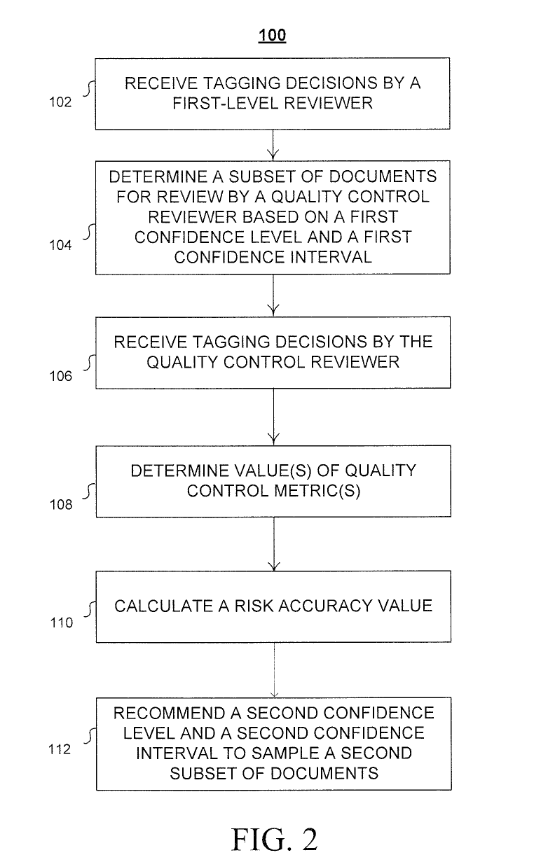

FIG. 1 shows an exemplary calculator system in an illustrative network environment. The network environment includes multiple user devices 914 configured to communicate with the calculator system 900 via an IP network 918. The calculator system 900 can in turn communicate with at least one storage module 912 for retrieving and storing pertinent data. In some embodiments, the calculator system 900 can communicate with a document review management system 916 (e.g., Relativity) via the IP network 918, where the document review management system 916 provides an e-discovery platform for FL and QC reviewers to review documents. The calculator system 900 includes one or more hardware modules configured to implement processes and/or software. As shown, the calculator system 900 includes a graphical user interface (GUI) module 901, an extraction module 902, a sampling module 904, a metrics module 906, a quality control calculator 908 and a recommendation module 910. In general, the calculator system 900 includes sufficient hardware and/or software components to implement the exemplary management process of FIG. 2.

The GUI module 901 of the calculator system 900 can handle user access (e.g., login and/or logout), user administration (e.g., any of the administration functions associated with the support and/or management of the system 900), widget management (e.g., providing the end user with the capability to arrange and save preferences for display of data within the browser area), and/or other GUI services.

The extraction module 902 can interact with the document review management system 916 to automatically obtain data related to reviews performed by FL and QC reviewers, such as tagging decisions made and documents reviewed by one or more reviewers in a specific time period and in relation to one or more legal disputes. In some embodiments, the extraction module 902 can retrieve the pertinent data from the storage module 912.

The sampling module 904 can identify a random sample of documents extracted by the extraction module 902, where the documents have been reviewed by at least one FL reviewer over a specific review period (but not checked by a QC reviewer). The sampled documents are determined by the sampling module 904 using statistical means based on a first confidence level and a first confidence threshold. In addition, the sampling module 904 can interact with the extraction module 902 to identify the tagging decisions made by the FL reviewer in relation to the sampled documents. The sampling module 904 can also (1) communicate to a user the identities of the sampled documents, such as by document names or ID numbers, via the GUI module 901 and (2) receive tagging decisions made by at least one QC reviewer in relation to the sampled documents that either confirm or disagree with the tagging decisions made by the FL reviewer.

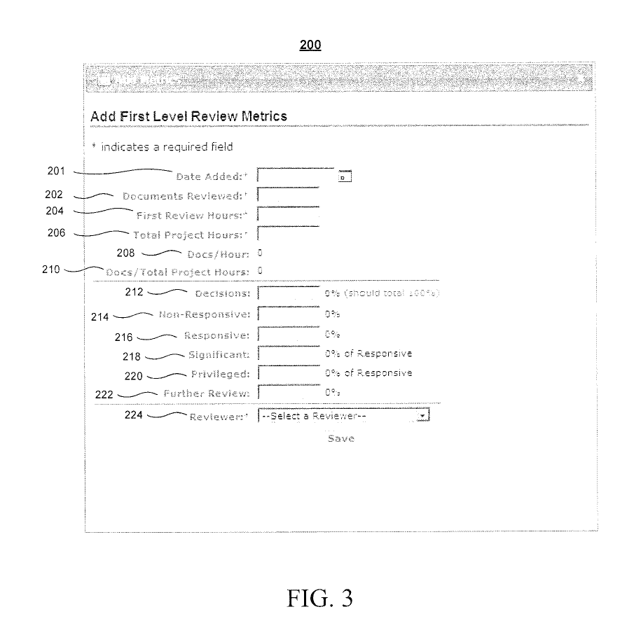

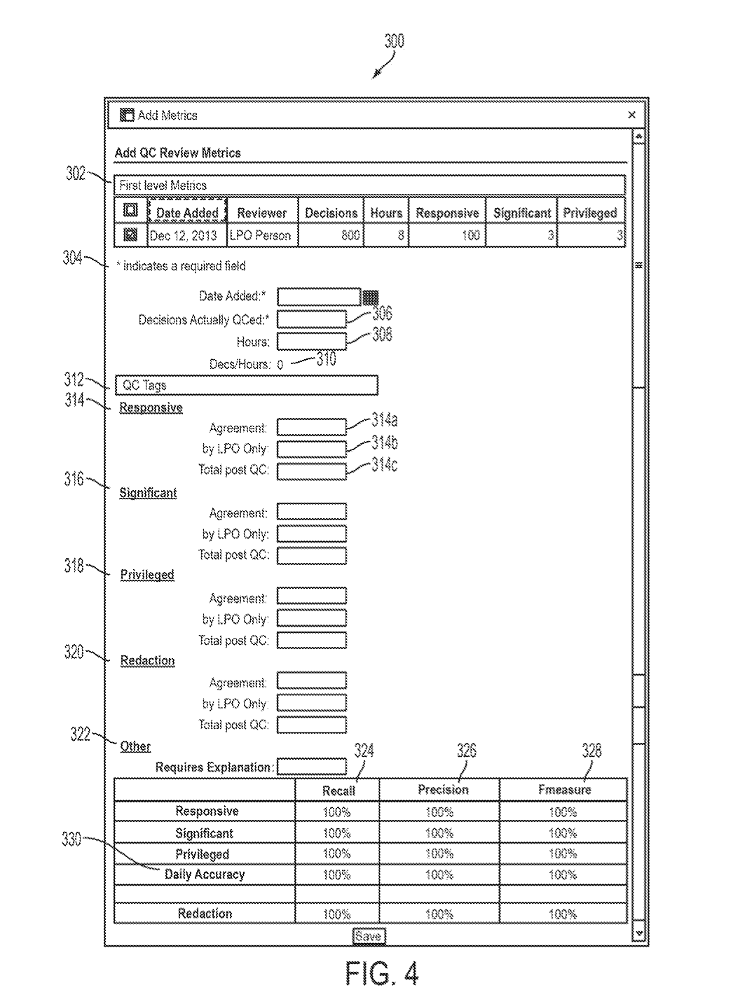

The metrics module 906 can generate one or more performance metrics based on the tagging decisions of the sampled documents made by the FL and QC reviewers. Specifically, the metrics module 906 can include a first level review module (not shown) configured to determine the values of one or more first level review metrics to characterize the performance of the FL reviewer during the review period. The metrics module 906 can also include a quality control review module (not shown) configured to compute the values of one or more quality control metrics that reflect the level of identity between the first and second reviewers in relation to the tagging decisions made by the reviewers with respect to the sampled documents. Hence, the quality control metrics evaluate the performance of the FL reviewer during the review period. Furthermore, the metrics module 906 can interact with the GUI module 901 to display the first level review metrics and the quality control metrics in one or more GUI interfaces, such as via the interface 200 of FIG. 3 and the interface 300 of FIG. 4.

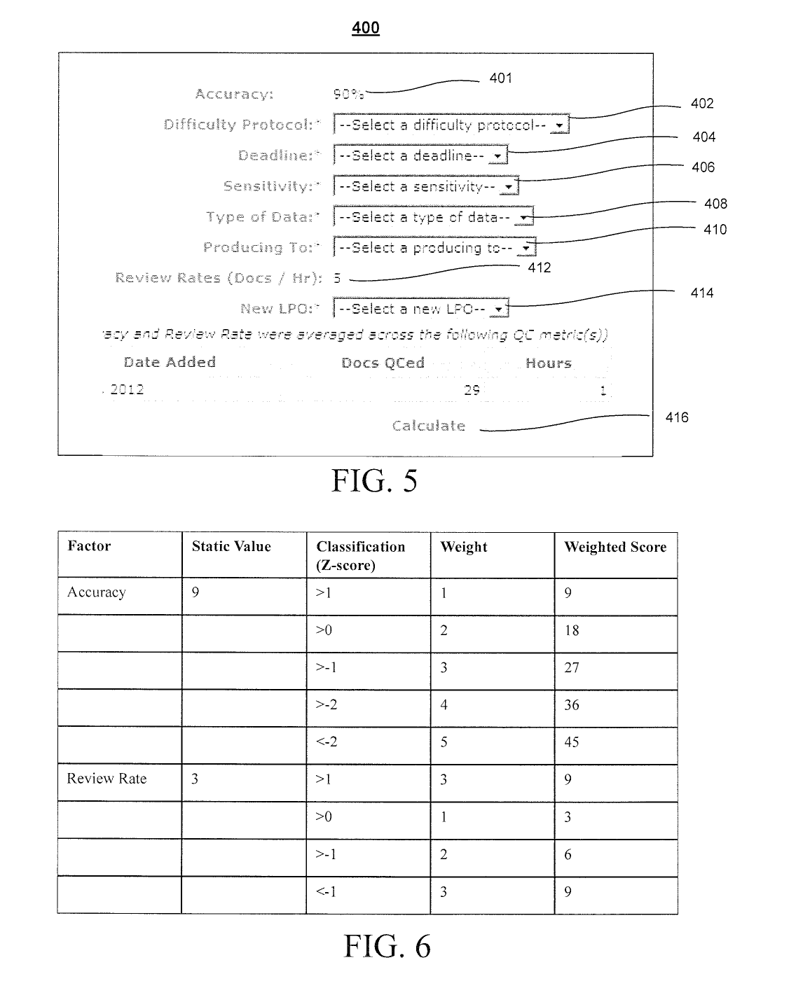

The quality control calculator 908 can compute a risk accuracy value as a weighted combination of one or more factors including (i) an accuracy factor determined based on the values of the metrics computed by the metrics module 906, (ii) a review rate factor indicating the rate of review of the FL reviewer, and (iii) one or more user-selectable factors that reflect the complexity associated with the documents reviewed. The quality control calculator 908 can interact with the GUI module 901 to display the factors via an interface, such as the interface 400 of FIG. 5. The resulting risk accuracy value can also be displayed to the user.

The recommendation module 910 can recommend a new confidence level and confidence interval based on the risk accuracy value computed by the quality control calculator 908. The new confidence level and interval can be used by the sampling module 904 to sample another batch of first-level reviewed documents in a subsequent time period to receive quality control check. The number of documents sampled is dependent on the risk accuracy value. For example, a higher risk accuracy value can indicate a certain problems with the current review process, such as a decrease in accuracy associated with the FL reviewer, an increase in difficulty or complexity of the documents reviewed or an abnormal review rate of the FL reviewer. Hence, a higher risk accuracy value can cause a larger number of documents to be sampled for the purpose of undergoing quality control review.

In some embodiments, the recommendation module 910 recommends an optimal review duration for a user-specified review process that minimizes costs while satisfying a desired accuracy threshold. The recommendation of the optimal review duration can be performed based on statistical data collected on historical review processes having similar characteristics. The recommendation module can also recommend the number of FL reviewers and/or the number of QC reviewers to staff to the desired review process to satisfy the optimal duration.

FIG. 2 shows an exemplary computerized process for automatically managing quality of human document review. The elements of the process 100 are described using the exemplary calculator system 900 of FIG. 1. As illustrated, the process 100 includes receiving tagging decisions for a batch of documents determined by at least one FL reviewer during a first time period 102, determining a subset of the batch of documents for review by at least one QC reviewer 104, where the subset of the documents are selected based on a first confidence level and a first confidence interval, receiving tagging decisions made by the QC reviewer in relation to the subset of documents 106, determining values of one or more quality control metrics by comparing the tagging decisions made by the QC and FL reviewers 108, calculating a risk accuracy value as a weighted combination of several factors 110 based at least in part on the quality control metrics, and recommending a second confidence level and a second confidence interval for sampling a second subset of the documents reviewed by the FL reviewer or another FL reviewer in a second time period 112.

At step 102, the calculator system 900 receives tagging decisions in relation to a batch of documents made by a FL reviewer during a first time period. Each tagging decision can be a decision made by the FL reviewer with respect to a single document or a family of documents (e.g., multiple related documents). As an example, a family of documents can comprise an email and its attachments. Often, the same tagging decision is applied to all documents within a family of documents. Each tagging decision can be a determination made by the FL reviewer regarding whether the document content satisfies one or more tagging criteria, including responsive, significant, privileged, and/or redaction required. In some embodiments, the tagging decisions made by the FL reviewer over a certain time period are gathered by the calculator system 900, where the time period can be a day, several days, or any user-specified range of time. In some embodiments, a FL reviewer is a contract attorney retained by a company for the purpose of performing document review in a legal dispute and a QC reviewer is an in-house attorney who may have more institutional understanding of the documents under review. Hence, the QC reviewer can review the documents with a higher level of accuracy and efficiency while the FL reviewer can be more cost effective.

In some embodiments, the calculator system 900 can compute the values of one or more first-level review metrics based on the tagging decisions made by the FL reviewer during the first time period (step 102). These values characterize and/or summarize the FL reviewer's performance during that time period. FIG. 3 shows an exemplary user interface 200 configured to display one or more first-level review metrics for measuring the performance of a FL reviewer during a first time period. As shown, the Date Added field 201 allows a user to enter the date on which the performance metrics are generated and the calculator system 900 can save the information entered via the interface 200 under that particular date. The Documents Reviewed field 202 allows a user to enter the number of documents reviewed by the FL reviewer over the first time period. The First Review Hours field 204 allows the user to enter the hours spent by the FL reviewer. The Total Project Hours field 206 allows a user to enter the total hours spent on the review (in step 102), including the hours spent by the FL reviewer, the QC reviewer, and manager(s) for the purpose of managing the review process. The Doc/Hours field 208 can be automatically populated by the calculator system 900 by dividing the document count in the Documents Reviewed field 202 by the hours in the First Review Hours field 204. Similarly, the Docs/Total Project Hours field 210 can be automatically populated by the calculator system 900 by dividing the document count in the Documents Reviewed field 202 by the hours in the Total Project Hours field 206. The Decisions field 212 allows the user to enter the total number of tagging decisions made by the FL reviewer during the first time period with respect to the documents reviewed, based on which the calculator system 900 can generate a percentage that can be displayed next to the field 212. The Non-Response field 214, Responsive field 216, Significant field 218, Privileged field 220, and Further Review field 222 allow the user to enter the numbers of non-responsive decisions, responsive decisions, significant decisions, privileged decision and decisions tagged for further review made by the FL reviewer, respectively. In addition, based on the value entered in each of these fields, the calculator system 900 can generate a percentage that is displayed next to the respective field. For example, the percentage associated with the Decisions field 212 can be 100% and the percentages associated with the Non-Responsive field 214, Responsive field 216, and Further Review field 222 can add up to the percentage corresponding the Decisions field 212. In addition, the sum of percentages associated with the Significant field 218 and Privileged field 220 can be equal to the percentage associated with the Responsive field 216. The Reviewer field 224 allows the user to select, from a drop-down menu for example, a QC reviewer to review the work produced of the FL reviewer.

In some embodiments, instead of asking the user to enter the information in the fields 202, 204, 206, 212, 214, 215, 218, 220 and 222, the calculator system 900 automatically populates these fields if the calculator system 900 maintains electronic communication with a document review management system (e.g., the document review management system 916 of FIG. 1) that tracks review data and statistics. In an exemplary implementation, the interface 200 is configured to display statistics related to the performance of one or more FL reviewers on a daily basis and a user can choose a QC reviewer, via the Reviewer field 224, to evaluate the work products by the one or more FL reviewers on a daily basis.

At step 104, a subset of documents can be sampled from the batch of documents reviewed by the FL reviewer during the first time period (from step 102). The number of documents sampled can be determined using a statistical algorithm, such as based on a confidence level, a confidence interval and the overall population size (i.e., the total number of documents in the batch from step 102). In general, the confidence level and interval are statistical measures for expressing the certainty that a sample of the document population is a true representation of the population. Specifically, the confidence interval represents a range of values computed from a sample that likely contain the true population value and the confidence level represents the likelihood that the true population value falls within the confidence interval. In some embodiments, the confidence level and confidence interval are provided to the calculator system 900 by a user, such as a team leader. Alternatively, the confidence level and confidence interval are recommended by the calculator system 900 based on the estimated quality of document review in a previous time period.

At step 106, the calculator system 900 receives tagging decisions by the QC reviewer with respect to the subset of documents sampled (from step 104). The QC reviewer can review each of the subset of documents to ensure that the documents are tagged correctly. The tagging decisions made by the QC reviewer can include corrections to FL reviewer's tagging decisions.

At step 108, based on the tagging decisions made by the QC and FL reviewers, the calculator system 900 can quantify the review quality of the FL reviewer during the first time period with respect to one or more quality control metrics. Specifically, the calculator system 900 can compute a value for each of the quality control metrics, where the values reflect the level of identity in the tagging decisions between the QC and FL reviewers. FIG. 4 shows an exemplary user interface 300 configured to display i) data related to the performance of the QC reviewer, ii) comparison of tagging decisions made by the FL and QC reviewers with respect to one or more tagging criteria and iii) values of quality control metrics computed by the calculator system 900 based on the comparison results. As shown, the interface 300 includes a First Level Metrics section 302 that allows a user to select one or more days of first level review metrics to be included in the quality control metrics calculation. The interface 300 also includes a section 304 for displaying values of certain metrics used to quantify the performance of the QC reviewer. This section 304 includes (i) the Decisions Actually Qced field 306 that allows a user to enter the number of tagging decisions made by the QC reviewer; (ii) the Hours field 308 that allows the user to enter the number of hours spent by the QC reviewer; and (iii) the Decs/Hours field 310 that can be automatically populated by the calculator system 900 by dividing the document count in the Decisions Actually Qced field 306 by the hours the Hours field 308.

The interface 300 also includes a QC Tags section 312 that compares the performance of the FL and QC reviewers during the first time period with respect to one or more tagging criteria, including responsiveness, significance, privileged status and redaction requirement. For example, in the Responsive subsection 314, the user can enter into the field 314a the number of responsive decisions that the FL reviewer made with which the QC reviewer agreed. The user can enter into the field 314b the number of responsive decisions that the FL reviewer made with which the QC reviewer removed/disagreed. The user can enter into the field 314c the total number or responsive decisions made by the QC reviewer after the quality control stage (performed in step 106) is completed. Similar data can be entered into the fields under the Significant subsection 316 with respect to the significant decisions, under the Privileged subsection 318 with respect to the privileged decisions, and under the Redaction subsection 320 with respect to the redaction required decisions. In the Requires Explanation field 322, the user can enter the number of tagging decisions that call into question the FL reviewer's understanding of basic concepts. In some embodiments, data entered by the user in the QC tag section 312 is based on the tagging decisions of the QC reviewer (from step 106) and the tagging decisions of the FL reviewer (from step 102). In some embodiments, the data in this section can be automatically obtained by the calculator system 900 if the calculator system 900 maintains electronic communication with a document review management system (e.g., the document review management system 916 of FIG. 1) that tracks review data and statistics.

The interface 300 further includes a section configured to display values of one or more quality control metrics computed by the calculator system 900 based on the data in the QC Tags section 312. Specifically, for each of the tagging criteria (responsive, significant, privileged and redaction), the calculator system 900 can compute at least one quality control metric comprising a recall rate 324, a precision rate 326 or an F-measure 328. In general, the recall rate 324 provides a measure of under tagging by the FL reviewer, which is the ratio of true positives to the sum of false negatives and true positives. The precision rate 326 provides a measure of over tagging by the FL reviewer, which is the ratio of true positives to the sum of false positives plus true positives. The F-measure provides a measure of the overall tagging accuracy by the FL reviewer.

For example, with respect to the responsive decisions, a recall rate 324 can be calculated by dividing the number of responsive decisions that the FL reviewer tagged with which the QC reviewer agrees (data from the field 314a) by the number of responsive decisions determined by the QC reviewer (data from the field 314c). A precision rate 326 can be calculated by dividing the number of responsive decisions tagged by the QC reviewer (data from the field 314c) by the sum of the number of responsive decisions tagged by the FL reviewer only and the number of responsive decisions tagged by the QC reviewer (data from field 314c). An F-measure 328 for each tagging criterion can be computed by dividing the product of the recall rate 324 and precision rate 326 for that criterion by the sum of the two rates. The same formulations can be used by the calculator system 900 to compute the recall rate, precision rate and F-measure for each of the tagging criteria. In general, each quality control metrics value can be expressed as a percentage. In addition, the calculator system 900 can calculate an accuracy percentage 330 associated with the first time period for each of the recall rate, precision rate and F-measure. For example, with respect to the recall rate 324, an accuracy percentage can be computed as an average of the recall rates corresponding to the responsive, significant and privileged decisions. The same formulation can be applied by the calculator system 900 to compute the accuracy percentages for the precision rate 326 and the F-measure 328.

As shown in FIGS. 3 and 4, the calculator system 900 can compute the first level metrics and the quality control metrics on a daily basis (i.e., the first time period is a day). Specifically, if the first time period is a day, the first level review metrics (as explained with reference to FIG. 3) and/or the quality control metrics (as explained with reference to FIG. 4) can be calculated for each day of review. In other embodiments, the calculator system 900 can aggregate these metrics across multiple dimensions, such as over several user-specified time periods and/or for a team of several FL reviewers. As an example, the calculator system 900 can aggregate daily metrics into averages and running totals that are updated continuously or periodically as additional review periods are specified. In some embodiments, a cumulative accuracy percentage for a FL reviewer or a team of FL reviewers is computed over a cumulative time period (i.e., consisting of several time periods), where the cumulative accuracy percentage is a weighted average of all the accuracy percentages computed for the time periods. For example, when computing the accuracy percentage over several days, each daily accuracy percentage 330 can be weighted based on the number of decisions made by the FL reviewer that day. This is because the accuracy for a day of review where 5,000 decisions were made is likely to contribute more heavily to the cumulative accuracy than a day where only 3,000 decisions were made. Similarly, a cumulative confidence level and confidence interval corresponding to several review periods can be computed as weighted averages of the confidence levels and intervals for the review periods, respectively. In general, cumulative metrics can include, for example, the total number of documents reviewed over the cumulative time period, the total number of hours spent by one or more FL reviewers, an average review rate of a FL reviewer, a percentage of completion, a cumulative accuracy percentage, a cumulative confidence level and confidence interval, and a percentage of documents that one or more QC reviewers considered responsive or significant over the cumulative time period.

At step 110, the calculator system 900 proceeds to compute a risk accuracy value based, at least in part, on one or more values of the quality control metrics (from step 108). The risk accuracy value can reflect a combination of reviewer performance (as quantified by the F-measures) and various elements that contribute to the level of risk the reviewed subject matter poses to the company. The calculator system 900 can use the risk accuracy value to determine the number of documents that will undergo quality control review by a QC reviewer in the next review period by generating, for example, a second confidence interval and confidence level.

FIG. 5 shows an exemplary user interface 400 configured to display one or more factors for calculating a risk accuracy value. The accuracy field 401 is automatically populated by the calculator system 900 based on the F-measure values 328 determined in FIG. 4. For example, the accuracy value can be a weighted average of the F-measures 328 calculated for responsive, significant and privileged decisions. The Difficulty Protocol field 402 allows a user to select the relative complexity level (e.g., simple or complex) of the issues and categories characterizing the FL reviewer's decisions, such as whether the review involves straightforward contract revisions or complex regulatory matters. The Deadline field 404 allows a user to select the type of deadline (e.g., expedited or standard) associated with the review during the first time period. The Sensitivity field 406 allows a user to select the sensitivity (high or low) of the subject matter reviewed in the context of the legal dispute. The Type of Data field 408 allows a user to select the complexity and variety (e.g., complex or simple) of the electronically stored information. For example, a review with all email communications is considered simple, as opposed to a review of a mix of email messages, chat communications, social media posts, and even structured database records. The Producing To field 410 allows a user to choose the type of litigation (civil, internal or regulatory) for which the document review during the first time period was conducted. The Review Rates field 412 can be automatically populated by the calculator system 900 to display the total number of documents reviewed per hour by the FL reviewer in a previous review period, such as in the previous day. The review rate is also compared to a system-wide average review rate, where a review rate that is too fast or too slow (as determined by distance away from average) leads to a higher risk calculation. The New LPO field 414 indicates whether the company has any experience (e.g., yes or no) working with the FL reviewer or team of FL reviewers. A “no” selection indicates that the risk associated with using the FL reviewer or team is high.

After one or more of the factors are specified, the user can activate the Calculate option 416. In response, the calculator system 900 computes a risk accuracy value as a sum of weighted scores, each weighted score being a weight multiplied by a static value.

$$Risk\_Accuracy = {\sum }_{k = 1}^{\# of Factors} {Weighted \_ Score}_{k} = {\sum }_{k = 1}^{\# of Factors} {Weight}_{k} \times {Static \_ Value}_{k} .$$

Each weighted score can correspond to a factor associated with one of the fields 401-414. Specifically, each static value quantifies the relative importance of the corresponding factor in contributing to the risk accuracy value. A static value can be specified by a team leader based on discussions with attorneys or assigned by the calculator system 900. For example, if an attorney considers accuracy to be the most important factor when determining the number of documents to undergo quality control review in the next time period, the attorney can specify a static value of 9 (on a scale of 1-9) for the accuracy factor (associated with the field 401). Each weight quantifies the classification corresponding to a factor in one of the fields 402-412. For example, for the Protocol Difficulty factor associated with the field 402, a weight is assigned a value of 1 if a simple protocol classification is selected or 2 if a complex protocol classification is selected. Classification of the accuracy value in the Accuracy field 401 can be based on its Z-score, which is calculated by dividing the difference between the accuracy value in the field 401 and the mean of the population by the standard deviation [Z-score=(x−μ/σ]. In general, a Z-score is used to assess how much a value deviates from the mean. Classification of the review rate value in the Review Rate field 412 can also be based on its Z-score.

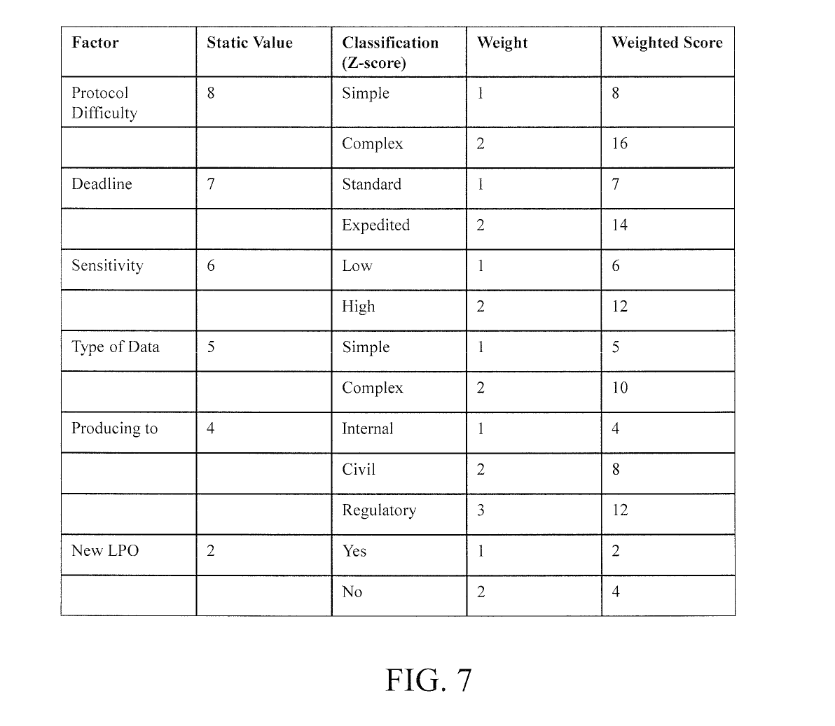

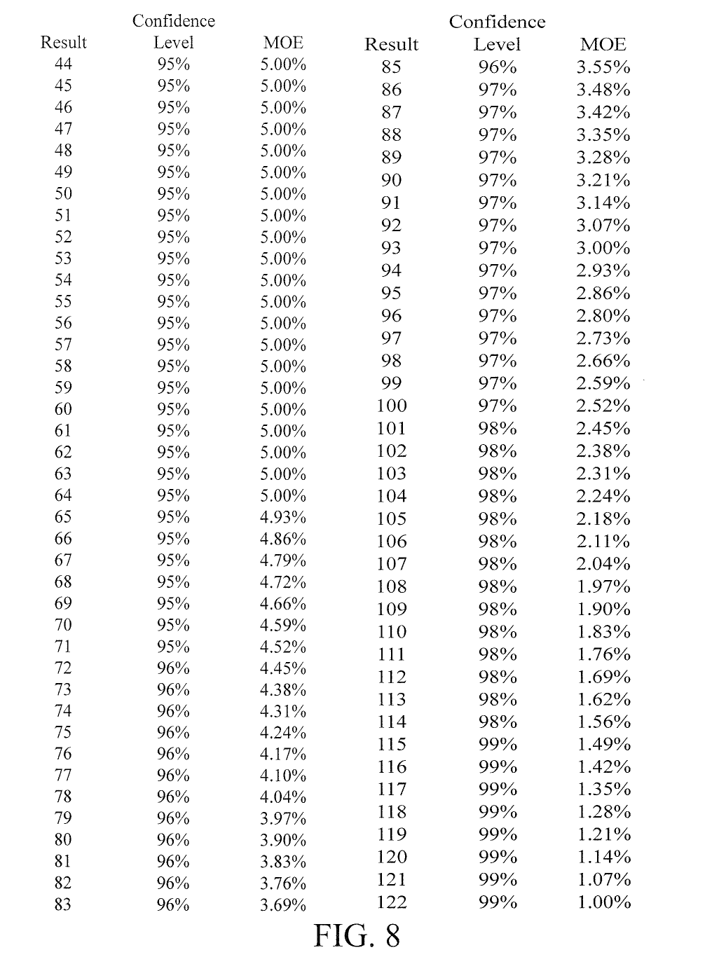

FIG. 6 shows an exemplary chart correlating the accuracy and review rate factors to their respective static values, classifications (z-scores), weights and weighted scores. As shown, as the z-score for accuracy becomes farther below the mean, the assigned weight increases to reflect that as the review accuracy becomes poorer, the resulting risk accuracy value increases. Consequently, more documents must undergo quality control check by a QC reviewer in the next review period. FIG. 6 also shows that as the z-score for the review rate deviates farther from the mean (either below or above), the assigned weight increases to reflect that if the review rate is either too fast or too slow, a greater number of document need to undergo quality control in the next review period. FIG. 7 shows an exemplary chart correlating additional factors to their respective static values, classifications, weights and weighted scores. These factors general evaluate the difficulty and complexity of the review process. The weighted score of each of the factors of FIG. 7 can contribute to the resulting risk accuracy value, along with the weighted scores of the accuracy factor and the review rate factor in FIG. 6. In general, the risk accuracy value tends to increase if the review process is particularly difficult and/or the legal dispute is complex.

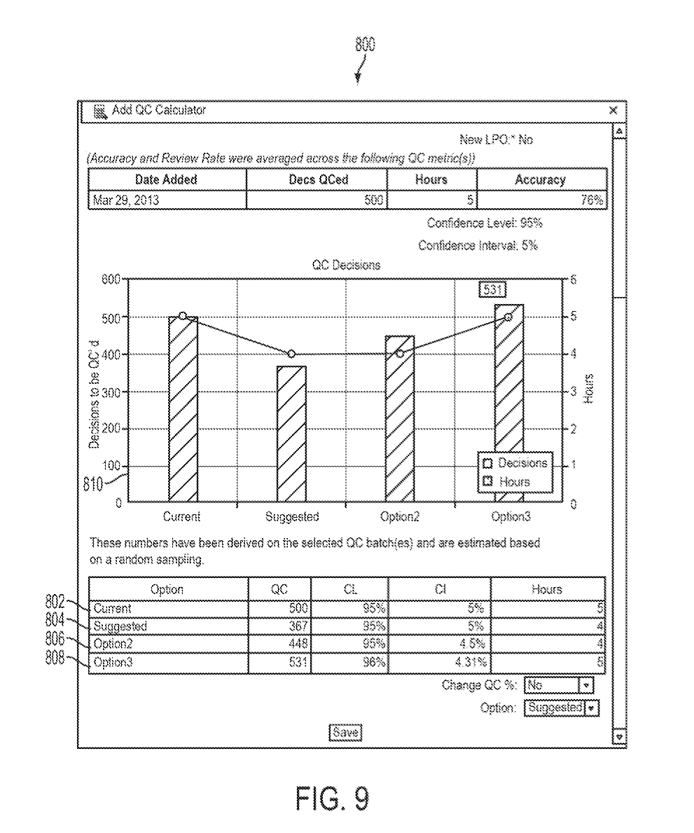

The calculator system 900 can compute a risk accuracy value that captures both the performance of the FL reviewer and the characteristics of the documents reviewed during the first time period based on one or more of the factors described above. At step 112, the calculator system 900 uses the risk accuracy value to determine a second (i.e. new) confidence level and confidence interval for sampling documents to receive quality control review in the second (i.e., next) review period, such as the next day. In some embodiments, the higher the risk accuracy value, the higher the confidence level and the lower the confidence interval, thus requiring more documents to be sampled in the next review period. An increase in the accuracy risk value can indicate a number of problems, including but not limited to a decrease in review accuracy, increase in the risk of matter being reviewed and/or a review rate that is either too fast or too slow. A lookup table, such as the one shown in FIG. 8, can be used to correlate various risk accuracy values with their respective confidence level and confidence interval recommendations. Alternative, an equation can be used to compute the confidence level and interval as a function of the risk accuracy value. Based on the new confidence level and interval, the calculator system 900 can determine the size of documents to be sampled from the existing population of first-level reviewed documents. The population of documents from which the sample is taken can include the documents that have been reviewed by a FL reviewer in the new period, but have not been quality-control checked by a QC reviewer.

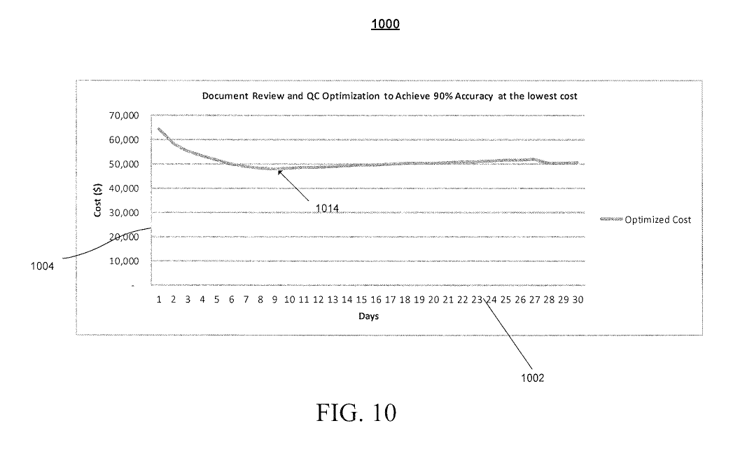

FIG. 9 shows an exemplary user interface 800 configured to display the recommended confidence level and confidence interval for sampling the next batch of documents. As shown, the Current row 802 displays the number of documents in a given time period that have been subjected to quality control check by a QC reviewer in the most recent round (i.e., during the first time period), along with the confidence level and confidence interval used to select these documents and the number of hours spent by the QC reviewer. A default confidence level of 95% and confidence interval of 5% can be used in the absence of any instructions from the user or recommendation by the calculator system 900, such as when the calculator system 900 is first run. The Suggested row 804 displays the recommended number of documents to be sampled in the next (i.e., second) time period for receiving quality control review, along with the recommended confidence level and confidence interval. The recommended confidence level and confidence interval can be determined based on the risk accuracy value calculated from the current review round (from step 110). In some embodiments, the recommended confidence level and confidence interval are required to be implemented in the next review period if the z-score of the suggested confidence level is less than 1 when compared to the confidence interval from the previous review period [Z-score=(Confidence_Interval_Recommended−Confidence_Interval_Current)/σ]. In some embodiments, the calculator system 900 also provides a prediction of the number of hours it would take the QC reviewer in the next time period to review the recommended number of documents. This prediction can be made based on the current quality control review rate as shown in the field 310 of FIG. 4, for example.

The interface 800 can also present the user with several additional options for setting the second confidence level and interval for the second review period. For example, The Option 2 row 806 shows the confidence level and interval generated based on a risk accuracy value that is five points higher that the risk accuracy value from the first (i.e. current) review period. This gives the user an option to account for greater risk by using a larger sample size. Similarly, the Option 3 row 808 shows the confidence level, confidence interval and sample size calculated based on a risk accuracy value that is ten points higher that the risk accuracy value from the first review period. The user has the discretion to choose among these options to change the sample size of the next batch of documents that will undergo quality control check. The interface 800 can additionally present to the user a visual representation of the options 802-808. For example, the QC Decisions graph 810 is a bar graph illustrating the document sample size for each of the four options, along with the predicted number of hours of quality control review for the corresponding option.

In some embodiments, the quality control process 100 of FIG. 2 is repeated over time during the lifetime of the document review process. For example, a sample of the first-level reviewed documents can be identified and subjected to quality control review on a daily or weekly basis as described in the steps 102-112 of the process 100. The sample size can vary depending on the accuracy of the FL reviewers in a previous review period combined with other factors. In some embodiments, the quality control process 100 of FIG. 2 is repeated over time only until the accuracy risk value reaches a predetermined threshold, at which point it is assumed that the FL reviewers are sufficiently trained to obviate the need for quality control review. In yet other embodiments, the quality control process 100 is performed sporadically or only once during a document review process.

In some embodiments, the calculator system 900 can recommend to a user the number of FL and/or QC reviewers to staff on a document review process, which can be determined based on one or more factors including speed, accuracy and cost. For example, the calculator system 900 can determine the optimal number of FL/QC reviewers to staff based on past review statistics including i) the review rate as shown in the field 412 of FIG. 5 and ii) the accuracy measure as shown in the accuracy field 401 of FIG. 5.

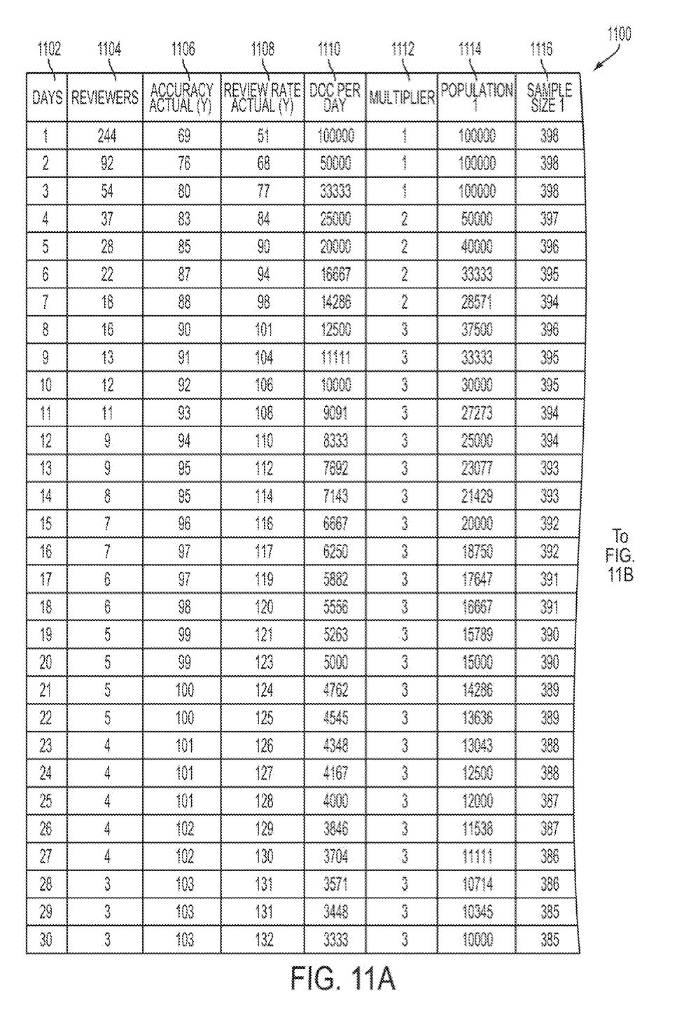

FIG. 10 shows an exemplary cost model utilizing logarithmic trend lines for determining the optimal duration of a document review process to achieve a given accuracy standard (e.g., at least 90% accurate) at the lowest cost. The determination of the optimal duration of a review ultimately affects the number FL reviewers staffed. The diagram 1000 can be created based on historical performance of FL reviewers in a company across matters having similar characteristics as the matter for which staffing recommendation is requested, such as based on statistics associated with matters of a certain complexity. The x-axis 1002 of the diagram 1000 indicates the duration of a review process, lasting anywhere from 1 to 30 days. The y-axis 1004 indicates the projected cost associated with a review of a specific duration. The optimized cost line 1010 plots the average cost corresponding to reviews staffed with a combination of FL and QC reviewers for a duration ranging from 1 to 30 days to achieve an accuracy rate of at least 90%. As shown in the example of FIG. 10, a 2-day review process is associated with an average cost of a little over $12,000 to achieve a review accuracy rate of at least 90%. The trend line 1010 reveals that the lowest cost for a review team of FL and QC reviewers is achieved for a review duration of 9 days, as indicated by the arrow 1014. This is understandable since 9 days gives the FL reviewers sufficient time to learn from feedback provided by the QC reviewers, enabling the FL reviewers to achieve a high level of review accuracy (e.g., 90%). In addition, 9 days of review is not excessive such that costs can increase dramatically for only incremental/minimal increase in accuracy. Therefore, for the example of FIG. 10, the calculator system 900 is likely to recommend a duration of 9 days for the review process of interest. Based on this recommendation, the user can make the appropriate staffing decisions to ensure that the recommended duration is achieved. In other examples, similar projected cost models can be created for reviews of different complexities, sizes, types and/or other classification criteria, based on which optimal review duration and staffing decision can be determined.

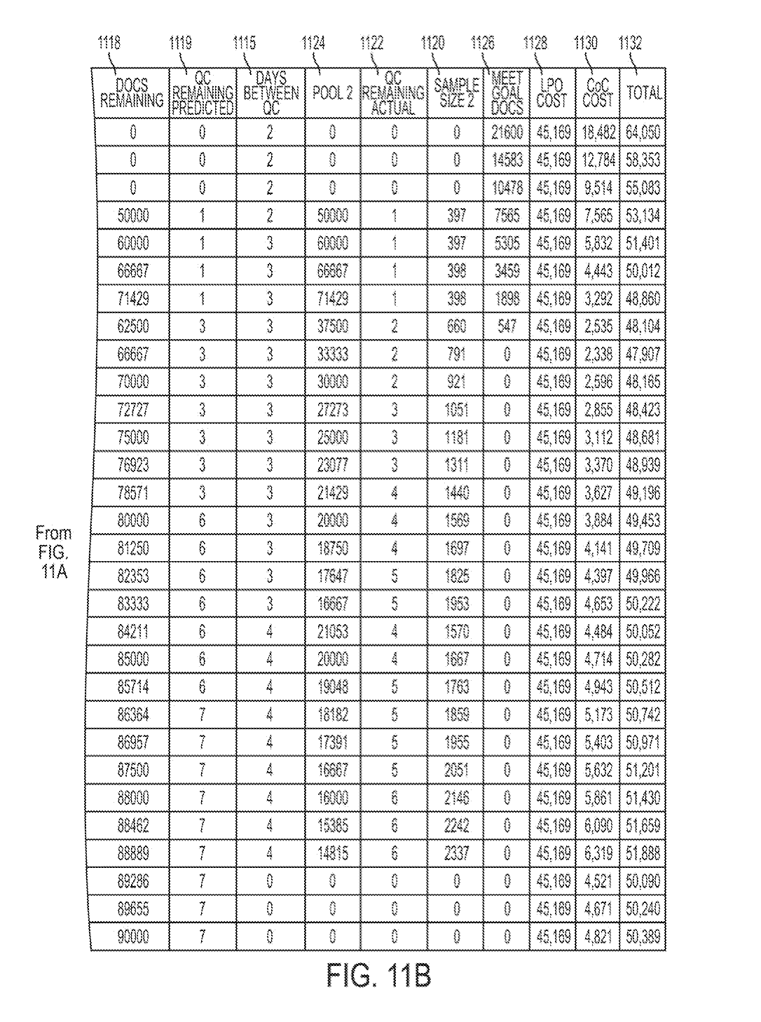

FIGS. 11A and 11B show an exemplary data table 1100 based on which the cost model of FIG. 10 is generated. The data table 1100 is created using data associated with document reviews having certain characteristics that are specifiable by the user. Each cell in the “days” column 1102 specifies a review duration and provides a fixed variable that the model uses to calculate the number of reviewers required for the corresponding duration. Each cell in the “reviewers” column 1104 indicates the number of FL reviewers required to complete a review in the given number of days provided in the corresponding “day” column 1102. This number can be calculated based on the corresponding value in the “review rate actual” column 1108 that indicates the projected review rate of the FL reviewers for each given duration. Each cell in the “accuracy actual” column 1106 indicates the projected accuracy rate for each given duration of review. This data can be determined based on historical accuracy metrics (e.g., from Accuracy field 401 of FIG. 4) associated with pertinent review processes previously completed. Each cell in the “doc per day” column 1110 indicates the expected number of documents reviewed per day for a review of a specific duration.

Each cell in the “multiplier” column 1112 indicates the number of days until the first quality control check is performed. Each “multiplier” value is used to calculate the value in the corresponding cell of the “population 1” column 1114 that indicates the number of documents potentially subjected to the first quality control check. In some embodiments, if the number of days of review (in the “day” column 1102) is less than a minimum number of days (e.g., 3), the corresponding cell in “multiplier” column 1112 can be assigned a value to indicate that the first quality control check starts on the second day after the review process commences. In this case, the corresponding cell in the “doc per day” column 1110 is ignored in the subsequent calculation and the corresponding value in the “population 1” column 1114 defaults to the total number of documents to be reviewed to indicate that only one round of quality control evaluation is needed, considering that the review duration is sufficiently short.

Each cell in the “population 1” column 1114 indicates the number of documents potentially subjected to the first quality control check. Each cell value is determined based on the number of consecutive days between the start of the document review process and the start of the first quality control evaluation (in the “multiplier” column 1112) and the expected number of documents reviewed per day (in the “doc per day” column 1110). In some embodiments, if the number of days of review (in the “days” column 1102) is less than a minimum number of days (e.g., 3), the corresponding value in the “population 1” column 1114 defaults to the total number of documents to be reviewed. Each cell in the “sample size 1” column 1116 represents the sample size of documents, out of the total number of documents subjected to the first quality control check (in the “population 1” column 1114), selected to actually undergo quality control review by the QC reviewers. This data can be calculated based on a sample size from the population of documents in the “population 1” column 1114, such as using the sample parameters indicated in the field 802 of FIG. 9 associated with pertinent processes previously completed.

Each cell in the “docs remaining” column 1118 indicates the number of documents that are left in the population after the first quality control evaluation. Each “docs remaining” value is calculated by subtracting the corresponding value in the “population 1” column 1114 from the total number of documents to be reviewed. Each cell in the “QC remaining predicted” column 1119 represents the predicted number of quality control checks remaining after the first quality control evaluation and is determined based on the number of quality control checks that should occur over a given duration of review (e.g., established under the company's best practice guidelines). Each cell in the “days between QC” column 1115 indicates the number of days between two successive quality control checks. Each cell in the “pool 2” column 1124 indicates the number of documents potentially subjected to each subsequent quality control check. If the “QCs remaining predicted” value of column 1119 is equal to 1 (i.e., only one additional quality control check is predicted), the value in the “pool 2” column 1124 defaults to the number of documents remaining (in the “docs remaining” column 1118). If there is more than one remaining quality control check predicted, the value in the “pool 2” column 1124 is calculated as the product of the expected number of documents reviewed per day (in the “doc per day” column 1110) and the number of days between two successive quality control checks (in the “days between QC” column 1115).

Because document volume and/or review rate can vary during a review process, it is difficult to predict the actual number of quality control checks that can occur before the review starts. Thus, values in the “QC remaining predicted” column 1119 serves as a baseline for calculating the actual number of quality control checks to occur (in the “QC remaining actual” column 1122) based on the volume and speed of review. Specifically, each value of the “QC remaining actual” column 1122 is determined by dividing the number of documents that are remaining after the first quality control check in the “docs remaining” column 1118 by the number of documents potentially subjected to each subsequent quality control check in the “pool 2” column 1124.

Each cell in the “sample size 2” column 1120 represents the sample size of documents, out of the total number of documents subjected to the subsequent quality control check (in the “pool 2” column 1124), selected to actually undergo each subsequent round of quality control review. This data can be calculated based on a sample size from the population of documents in the “pool 2” column 1124 and the number of actual quality control checks remaining in the “QC remaining actual” column 1122.

Each cell in the “meet goal docs” column 1126 indicates the number of documents that need to undergo quality control evaluation for a review of a particular duration in order to achieve a predetermined accuracy rate, such as 90%. To compute each cell in the meet goal docs” column 1126, the number of potential errors that remain in the population is first calculated based on the actual accuracy provided in the corresponding cell of column 1106. The difference between the actual accuracy and the goal accuracy is then determined and the percentage is applied to the remaining number of documents in Pool 2 of column 1124. The number of documents to undergo quality control review to achieve the goal accuracy, as shown in the “Meet goal doc” column 1126, is calculated based on this percentage. Each cell in the “LPO cost” column 1128 indicates the predicted cost of FL reviewers for a document review of a specific duration. Each cell in the “CoC cost” column 1130 indicates the predicted cost of QC reviewers for a document review of a specific duration. The “total” column 1132 indicates the total cost (i.e., sum of costs of the FL and QC reviewers) for a document review of a specific duration. Data in this column can be used to plot the trend line 1010 of the diagram 1000 in FIG. 10.

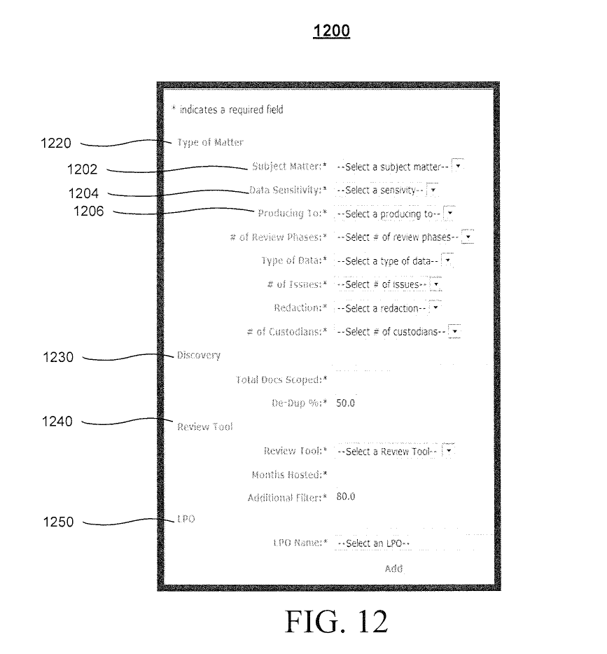

FIG. 12 shows an exemplary user interface for allowing a user to specify parameters associated with a document review process for which duration, staffing breakdown and cost recommendations are generated. In general, the user interface 1200 is divided into four regions. The Type of Matter region 1220 allows the user to categorize the matter to be reviewed based on a number of factor contributing to the complexity of the review process. For example, the user can select in the Subject Matter field 1202 the complexity of review, including standard, simple or complex. The user can select in the Data Sensitivity field 1204 the sensitivity (high or low) of the subject matter to be reviewed. The user can select in the Producing To field 1206 the type of litigation (civil, internal or regulatory) for which the document review will be conducted. The Discovery region 1230 generally allows the user to estimate the volume of documents for review. The Review Tool region 1240 generally allows the user to estimate costs associated with the review tool used by the FL and/or QC reviewers to perform document review. The LPO review region 1250, which includes the LPO Name field, allows the user to specify at least one FL reviewer who will conduct the document review or the agency hired to perform the first-level reviews.

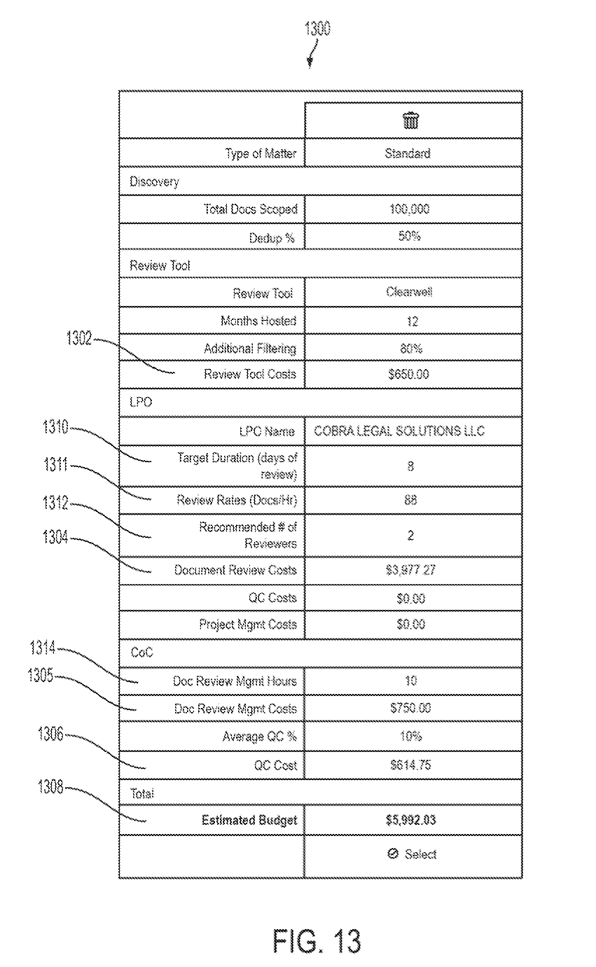

FIG. 13 illustrates an exemplary display configured to show the user various estimations and staffing recommendations for an exemplary document review process (with characteristics described by the user via the user interface 1200 of FIG. 12). The calculator system 900 can generate the recommendations and estimations using the algorithms described above with respect to FIGS. 10 and 11. Specifically, for a document review process of interest, the display 1300 can show the estimated costs associated with the review tools used (Review Tool Costs field 1302), the document review costs by the first level reviewers (Document Review Costs field 1304), the quality control costs by the QC reviewers (QC Cost field 1306), the management costs (Doc Review Mgmt Costs field 1305) and the total estimated cost (Estimated Budget field 1308). The display 1300 can also recommend to the user the number of days the review needs to be completed to achieve a certain accuracy standard while minimizing costs (Target Duration field 1310), the number of FL reviewers recommended (Recommended # of Reviewers field 1312) and the predicted review rate (Review Rates field 1311) to realize the review goal, as well as the number of quality control hours required (Doc Review Mgmt Hours field 1314). In some embodiments, the number of FL reviewers recommended can be determined based on the expected volume of documents to be reviewed per day for a review of a certain duration and historical review rates of FL reviewers (e.g., from the field 412 of FIG. 5) associated with completed review processes of similar complexity at the optimal duration. An average of the historical review rates can be displayed in the Review Rates field 1311 of FIG. 13.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites.

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, both general and special purpose microprocessors, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computer in communication with a display device, e.g., a CRT (cathode ray tube), plasma, or LCD (liquid crystal display) monitor, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system (e.g., a cloud-computing system) that includes any combination of such back-end, middleware, or front-end components.

Communication networks can include one or more packet-based networks and/or one or more circuit-based networks in any configuration. Packet-based networks can include, for example, an Ethernet-based network (e.g., traditional Ethernet as defined by the IEEE or Carrier Ethernet as defined by the Metro Ethernet Forum (MEF)), an ATM-based network, a carrier Internet Protocol (IP) network (LAN, WAN, or the like), a private IP network, an IP private branch exchange (IPBX), a wireless network (e.g., a Radio Access Network (RAN)), and/or other packet-based networks. Circuit-based networks can include, for example, the Public Switched Telephone Network (PSTN), a legacy private branch exchange (PBX), a wireless network (e.g., a RAN), and/or other circuit-based networks. Carrier Ethernet can be used to provide point-to-point connectivity (e.g., new circuits and TDM replacement), point-to-multipoint (e.g., IPTV and content delivery), and/or multipoint-to-multipoint (e.g., Enterprise VPNs and Metro LANs). Carrier Ethernet advantageously provides for a lower cost per megabit and more granular bandwidth options.

Devices of the computing system can include, for example, a computer, a computer with a browser device, a telephone, an IP phone, a mobile device (e.g., cellular phone, personal digital assistant (PDA) device, laptop computer, electronic mail device), and/or other communication devices. The browser device includes, for example, a computer (e.g., desktop computer, laptop computer, mobile device) with a world wide web browser (e.g., Microsoft® Internet Explorer® available from Microsoft Corporation, Mozilla® Firefox available from Mozilla Corporation).

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

1. A computerized method for automatically managing quality of human document review in a review process, the method comprising:
receiving, by an extraction hardware module of a computing device, tagging decisions for a plurality of documents made by a first reviewer during a first time period;
determining, by a sampling hardware module of the computing device, a subset of the plurality documents based on a first confidence level and first confidence interval;
receiving, by the sampling hardware module of the computing device, tagging decisions made by a second reviewer related to the subset of the plurality of documents;
determining, by a quality-control review hardware module of the computing device, values of a plurality of quality-control metrics based on the tagging decisions of the first and second reviewers with respect to the subset of the plurality of documents, wherein the values of the plurality of quality-control metrics reflect a level of identity between the first and second reviewers in relation to a plurality of tagging criteria;
displaying, by a graphical user interface (GUI) hardware module of the computing device, a graphical user interface on a display device coupled to the computing device, the graphical user interface comprising
a first section having a user input field configured to enable selection of one or more days of the first time period that defines a date range of tagging decisions made by the first reviewer to include in the determining values step,
a second section having a plurality of user input fields configured to enable entry of data relating to the tagging decisions made by the second reviewer, and
a third section having a visual comparison of the plurality of quality-control metrics between the first and second reviewers in relation to the plurality of tagging criteria;
calculating, by a quality-control calculator hardware module of the computing device, a risk-accuracy value as a weighted combination of a plurality of factors including (1) an accuracy factor determined based on the values of the plurality of quality-control metrics; (2) a review rate factor indicating the rate of review of the first reviewer during the first time period; and (3) one or more user-selectable factors reflecting the complexity or difficulty associated with reviewing the plurality of documents; and
recommending, by a recommendation hardware module of the computing device, a second confidence level and a second confidence interval for sampling a second plurality of documents reviewed during a second time period, wherein the second confidence level and the second confidence interval are determined based on the risk-accuracy value.

2. The method of claim 1, wherein the tagging criteria comprise responsiveness, significance, privileged and redaction requirement.

3. The method of claim 1, wherein each tagging decision comprises a decision regarding whether a family of one or more related documents satisfies at least one of the tagging criteria.

4. The method of claim 1, further comprising calculating, by the computing device, values of a plurality of first-level review metrics corresponding to the tagging decisions made by the first reviewer.

5. The method of claim 4, wherein the value of at least one of the first-level review metrics indicates a percentage of the tagging decisions that satisfies a tagging criterion.

6. The method of claim 4, further comprising computing, by the computing device, the value of each of the first-level review metrics as an average over a user-selectable time period.

7. The method of claim 1, wherein the plurality of quality control metrics comprise a recall rate, a precision rate and an F-measure for each of the plurality of tagging criteria.

8. The method of claim 7, further comprising:
computing, by the computing device, the recall rate and the precision rate corresponding to each of the plurality of tagging criteria based on a percentage of agreement of tagging decisions between the first and second reviewers with respect to the corresponding tagging criterion; and
computing, by the computing device, the F-measure corresponding to each of the plurality of tagging criteria based on the corresponding recall rate and precision rate.

9. The method of claim 8, wherein the accuracy factor comprises a weighted average of the F-measures for the plurality of tagging criteria.

10. The method of claim 1, wherein the one or more user-selectable factors comprise a difficulty protocol factor, a deadline factor, a sensitivity factor and a type of data factor.

11. The method of claim 1, further comprising, receiving, by the computing device, a plurality of weights corresponding to the plurality of factors for customizing the calculation of the risk-accuracy value.

12. The method of claim 1, wherein the second confidence level is inversely related to the risk-accuracy value.

13. The method of claim 12, wherein an increase in the risk-accuracy value is indicative of a decrease in accuracy of the first reviewer, an increase in difficulty or complexity of the plurality of documents reviewed, or an abnormal review rate of the first reviewer.

14. The method of claim 1, wherein the first time period is a current day and the second time period is the following day.

15. The method of claim 1, further comprising calculating, by the computing device, a plurality of cumulative metrics for a duration of the review process, the plurality of cumulative metrics comprising at least one of the total number documents reviewed, the total number of hours spent by the first reviewer, an average review rate of the first reviewer, a percentage of completion, an overall accuracy value of the first reviewer, an average confidence level, or an average confidence interval.

16. The method of claim 15, further comprising:
receiving data related to a second review process similar to the review process, the data including an accuracy threshold to be achieved by the second review process;
gathering a plurality of historical cumulative metrics data, including the plurality of cumulative metrics for the review process and one or more cumulative metrics associated with other review processes similar to the second review process;
determining, based on the historical cumulative metrics data, a cost model illustrating average costs for similar review processes of various durations to achieve the accuracy threshold; and
determining, based on the cost model, an optimal duration for the second review process that minimizes costs while satisfying the accuracy threshold.

17. The method of claim 16, further comprising recommending, based on the optimal duration for the second review process, at least one of a number of first-level reviewers or a number of quality-control reviewers to staff to the second review process to realize the optimal duration.

18. The method of claim 16, further comprising estimating a cost associated with completing the second review process in the optimal duration.

19. The method of claim 16, further comprising determining a degree of similarity between the second review process and the other review processes based on a complexity score for each of the review processes.

20. The method of claim 16, wherein the optimal duration corresponds to a point in the cost model with the lowest average cost.

21. A computer-implemented system for automatically managing quality of human document review in a review process, the computer-implemented system comprising a plurality of hardware modules each coupled to a processor and a memory of a computing device, the hardware modules including an extraction module, a sampling module, a graphical user interface (GUI) module, a quality-control review module, a quality-control calculator module, and a recommendation module:
the extraction module comprising registers and instructions for extracting tagging decisions for a plurality of documents made by a first reviewer during a first time period;
the sampling module comprising registers and instructions for (i) determining a subset of the plurality documents based on a first confidence level and first confidence interval and (ii) receiving tagging decisions made by a second reviewer related to the subset of the plurality of documents;
the quality-control review module comprising registers and instructions for determining values of a plurality of quality-control metrics based on the tagging decisions of the first and second reviewers with respect to the subset of the plurality of documents, wherein the values of the plurality of quality-control metrics reflect levels of identity between the first and second reviewers in relation to a plurality of tagging criteria;
the graphical user interface (GUI) module comprising registers and instructions for displaying a graphical user interface on a display device coupled to the computing device, the graphical user interface comprising
a first section having a user input field configured to enable selection of one or more days of the first time period that defines a date range of tagging decisions made by the first reviewer to include in the determining values step,
a second section having a plurality of user input fields configured to enable entry of data relating to the tagging decisions made by the second reviewer, and
a third section having a visual comparison of the plurality of quality-control metrics between the first and second reviewers in relation to the plurality of tagging criteria;
the quality-control calculator comprising registers and instructions for calculating a risk-accuracy value as a weighted combination of a plurality of factors including (1) an accuracy factor determined based on the values of the plurality of quality-control metrics; (2) a review rate factor indicating the rate of review of the first reviewer during the first time period; and (3) one or more user-selectable factors reflecting the complexity associated with reviewing the plurality of documents; and
a recommendation module comprising registers and instructions for recommending a second confidence level and a second confidence interval for sampling a second plurality of documents reviewed by the first reviewer during a second time period, wherein the second confidence level and the second confidence interval are determined based on the risk-accuracy value.

22. The computer-implemented system of claim 21, wherein the tagging criteria comprise responsiveness, significance, privileged and redaction requirement.

23. The computer-implemented system of claim 21, further comprising a first level review module configured to calculate values of a plurality of first-level review metrics corresponding to the tagging decisions made by the first reviewer.

24. The computer-implemented system of claim 21, wherein the plurality of quality-control metrics comprise a recall rate, a precision rate and an F-measure computed with respect to each of the plurality of tagging criteria.

25. The computer-implemented system of claim 21, wherein the recommendation module is further configured to:
receive data related to a second review process similar to the review process, the data including an accuracy threshold to be achieved by the second review process;
determine a plurality of historical cumulative metrics data for the review process and other review processes similar to the second review process;
determine, based on the historical cumulative metrics data, a cost model illustrating average costs for similar review processes of various durations to achieve the accuracy threshold; and
determine, based on the cost model, an optimal duration for the second review process that minimizes costs while satisfying the accuracy threshold.

26. The computer-implemented system of claim 21, wherein the recommendation module is further configured to recommend, based on the optimal duration for the second review process, at least one of a number of first-level reviewers or a number of quality-control reviewers to staff to the second review process to realize the optimal duration.

27. The computer-implemented system of claim 21, wherein the recommendation module is further configured to recommend a cost associated with completing the second review process in the optimal duration.

28. The computer-implemented system of claim 21, wherein the optimal duration corresponds to a point in the cost model with the lowest average cost.

29. The computer-implemented system of claim 21, wherein the recommendation module is further configured to determine a degree of similarity between the second review process and the other review processes based on a complexity score for each of the review processes.

30. A computer program product, tangibly embodied in a non-transitory computer readable medium, for automatically managing quality of human document review in a review process, the computer program product including instructions being configured to cause a plurality of hardware modules each coupled to a processor and a memory of a computing device, the hardware modules including an extraction module, a sampling module, a graphical user interface (GUI) module, a quality-control review module, a quality-control calculator module, and a recommendation module to:
receive, by the extraction module, tagging decisions for a plurality of documents made by a first reviewer during a first time period;
determine, by the sampling module, a subset of the plurality documents based on a first confidence level and first confidence interval;
receive, by the sampling module, tagging decisions made by a second reviewer related to the subset of the plurality of documents;
determine, by the quality-control review module, values of a plurality of quality-control metrics based on the tagging decisions of the first and second reviewers with respect to the subset of the plurality of documents, wherein the values of the plurality of quality-control metrics reflect levels of identity between the first and second reviewers in relation to a plurality of tagging criteria;
display, by the graphical user interface (GUI) module, a graphical user interface on a display device coupled to the computing device, the graphical user interface comprising
a first section having a user input field configured to enable selection of one or more days of the first time period that defines a date range of tagging decisions made by the first reviewer to include in the determining values step,
a second section having a plurality of user input fields configured to enable entry of data relating to the tagging decisions made by the second reviewer, and
a third section having a visual comparison of the plurality of quality-control metrics between the first and second reviewers in relation to the plurality of tagging criteria;
calculate, by the quality control calculator module, a risk-accuracy value as a weighted combination of a plurality of factors including (1) an accuracy factor determined based on the values of the plurality of quality-control metrics; (2) a review rate factor indicating the rate of review of the first reviewer during the first time period; and (3) one or more user-selectable factors reflecting the complexity associated with reviewing the plurality of documents; and
recommend, by the recommendation module, a second confidence level and a second confidence interval for sampling a second plurality of documents reviewed by the first reviewer during a second time period, wherein the second confidence level and the second confidence interval are determined based on the risk-accuracy value.
